(19) United States
(12) Patent Application Publication
(10) Pub. No.: US 2018/0186569 A1
(43) Pub. Date: Jul. 5, 2018

(54) ERGONOMIC STORAGE

(71) Applicant: D.C.AN.S, Conde En Normandie (FR)

(72) Inventor: Thierry Gevrey, Conde Sur Noireau (FR)

(73) Assignee: O.C.AN.S, Conde En Normandie (FR)

(21) Appl. No.: 15/741,385

(22) PCT Filed: Jul. 1, 2016
(86) PCT No.: PCT/FR2016/000112

§ 371 Date: Jan. 2, 2018

(30) Foreign Application Priority Data
Jul. 7, 2015 (FR) 1501451

(51) Int. Cl. B65G 1/06; A47B 51/00

(52) U.S. Cl. CPC B65G 1/06; A61G 12/00; A47B 51/00

(57) ABSTRACT

The present invention relates to a device which makes it possible to use the maximum height of the room or of the warehouse in a storage zone without using a forklift truck apparatus or, more simply, a chair or ladder. The device allows contents located outside an ergonomic zone to be made accessible by moving them in order to bring them within the reach of every user. The device adapts its dimensions (height, width, depth, volume) to all types of storage conditions, whether for a kitchen unit, an office unit or a storage rack. This invention promotes independence of disabled persons (in a wheelchair or the like), by increasing and facilitating their access to inaccessible storage, while reducing the floor space taken up.

### CROSS-REFERENCE TO RELATED APPLICATIONS

This application is a § 371 filing of PCT application PCT/FR2016/000112 filed on Jul. 1, 2016, which claims priority from French application FR 1501451 filed on Jul. 7, 2015. The disclosures of these applications are included by reference herein in their entirety.

### BACKGROUND

### Field of the Invention

The present invention relates to a device, which can be integrated into a unit, within a room, allowing anyone to use, in an ergonomic manner (without a booster-seat type accessory), the large amount of available and unused storage space of a living room (kitchen, dressing room, or otherwise) or of a professional space (office, repository, workshop, or otherwise) by exploiting the total (or partial) height of the location where this unit (equipment) is installed while reducing the floor space taken up.

### Description of Related Art

Whatever the location (housing, offices, etc.), the storage spaces, warehouses and repositories are still insufficient despite the large floor areas devoted to them. While the standard height of rooms in a dwelling is 2.5 meters (at least), current units are limited in height (usually 1.8 m). Storage at a greater height (>1.8 m) is not ergonomic for a normal user; the height exploitation of said space imposes the use of a booster-seat in order to reach objects arranged at the top, but falling from a height with objects is an accident analysis criterion that is very relevant in both a private or professional context. Moreover, a vertical storage space, located below 0.4 meters or above 1.3 meters (from 0.7 m to 1.1 m recommended for drawer access), is completely inaccessible to a wheelchair user. Currently, for people in wheelchairs, equipment can lower (or raise) the shelf of a piece of furniture (or the unit), but current solutions, corresponding to vertical movement or simultaneous horizontal and vertical movements, do not allow storage there beneath. In addition, those mechanisms that are marketed are bulky and limit the storage volume. These solutions improve ergonomics but do not increase the storage volume available.

### BRIEF SUMMARY OF ASPECTS OF THE INVENTION

The present invention relates to equipment (or a unit) that is manually handled or that has motorized assistance, (partially or entirely), and that is adaptable to existing items, making it possible to significantly increase the storage volume thereof for the same occupied floor area, while ensuring ergonomic access for every user. The invention is modular, according to the requirements and usability level of the user, it makes it possible to combine traditional storage zones (drawers, shelves, racks, etc.) without the use of the mechanisms of the invention and out of reach zones with the use of the system. The use of the total height of the location increases the storage volume and liberates floor space such as to facilitate the mobility of persons.

### BRIEF DESCRIPTION OF THE DRAWINGS

The present invention will be understood better in light of the following detailed description with reference to the accompanying drawings, wherein:

FIG. 1 is a schematic representation (cross-sectional side view) of the device and shows the different levels of accessibility for a person.

FIG. 2 (schematic representation in ISO view) shows the equipped module, consisting of two ladders (FIG. 3) and several containers of different heights (FIG. 4).

FIG. 5 corresponds to a front view of the device.

FIG. 6 corresponds to a side view of the device in the retracted position.

FIG. 7 corresponds to a side view of the device in the extended position.

FIGS. 8 to 11 show top views of the unit.

FIGS. 12 (unit closed) and 13 (unit open) show side views.

FIGS. 14 and 15 show top views of the unit, equipped with a single ladder (13).

FIGS. 16 and 17 show top views of the unit, equipped with two ladders (13).

FIGS. 18 (closed position) and 19 (open position) show top views of a unit used as a “separating wall” for two rooms (or locations).

FIG. 20 show a side view of the unit, equipped with protection (20).

### DETAILED DESCRIPTION OF ASPECTS OF THE INVENTION

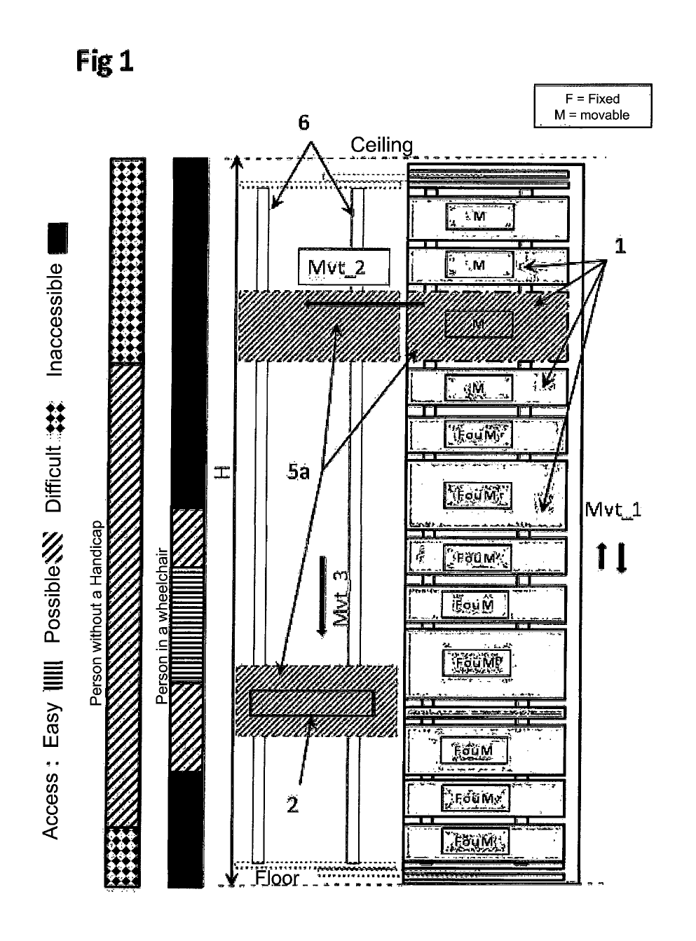

The device according to the invention allows for the exploitation of free storage spaces located in inaccessible areas (FIG. 1 upper or lower) without the use of an accessory (chair, booster-seat, frame, platform, lift, etc.). The modular concept adapts itself to the ergonomics of every user, providing safety and autonomy and increasing the amount of free surface on the ground, and overcomes the disadvantages mentioned above. The device provides every user with the possibility to appropriate storage zone(s), located over the entire height of a room (house, office, workshop), thereby taking it up to a height corresponding to the accessibility thereof. Every user accesses “out of reach” storage; the concept acquires the shelf (rack, compartment, container, etc.) required by the individual, horizontally translates (on the front of the unit) the compartment, and then lowers it to the ergonomic height of the person. The principle is to successively allow for the horizontal and vertical displacement of a storage zone (or several shelves), in order to exploit storage over the entire height of the unit.

In regard to a private dwelling, the diagram (FIG. 1) shows a “unit” equipped with many compartments (1) stacked in a column. A standard accessible ergonomic zone (FIG. 1 oblique hatching) corresponds to 64% of the height of the room for a person with the ability to perform certain actions from daily life and less than 37% for a person in a wheelchair or less than 20% when taking comfortable heights into consideration (from 0.7 m to 1.1 m recommended for drawer access). The operating concept consists in mounting a shuttle (Platform Mvt_1) making it possible to hang the desired compartment (1 hatched), transfer it (Mvt_2), and then lower it (Mvt_3) to the height required by the user. The person takes the required objects and returns the compartment (1 hatched) to the location thereof by reversing the cycle (Mvt_3−Mvt_2−Mvt_1) and releases the compartment (1 hatched). The entire cycle is either mechanical with manual control of certain movements or automated in order to simplify the usage thereof.

A person who is unable to perform certain daily living activities (wheelchair, tendinitis of the upper limbs, elderly, back pain, small or large in stature, etc.), whether on a personal or professional level, is penalized by limited access to certain upper zones of his environment, thus being deprived of autonomy. The device makes it possible to store any type of object, associated with an activity, within hitherto free zones (unused), which in return provides for the release of ground surface within which to circulate.

The invention is applicable to all locations (homes, government offices, storage zones) having a ceiling height that is not being exploited or that is accessible only by means of the use of equipment (chair, booster-seat, platform, forklift truck, etc.). In more specific locations (cold room, air conditioned room, repository, etc.), the use of the invention reduces the floor space of the location (investment and energy gains).

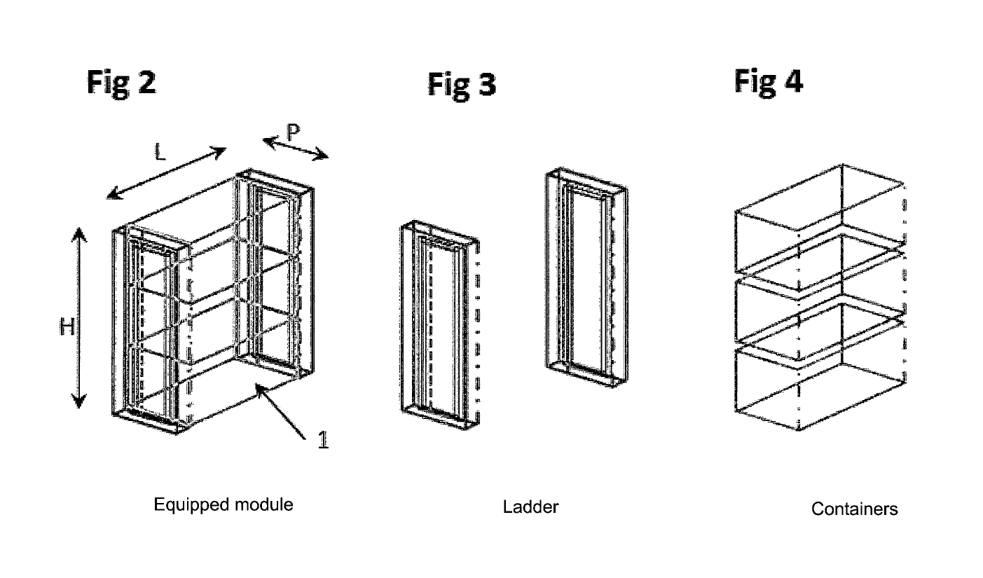

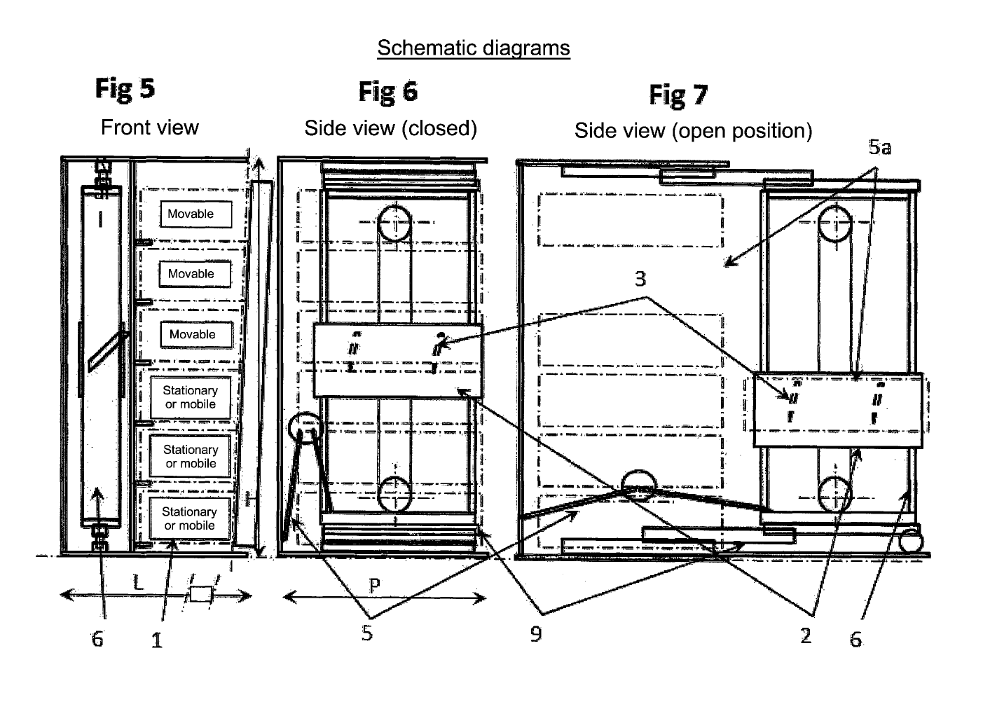

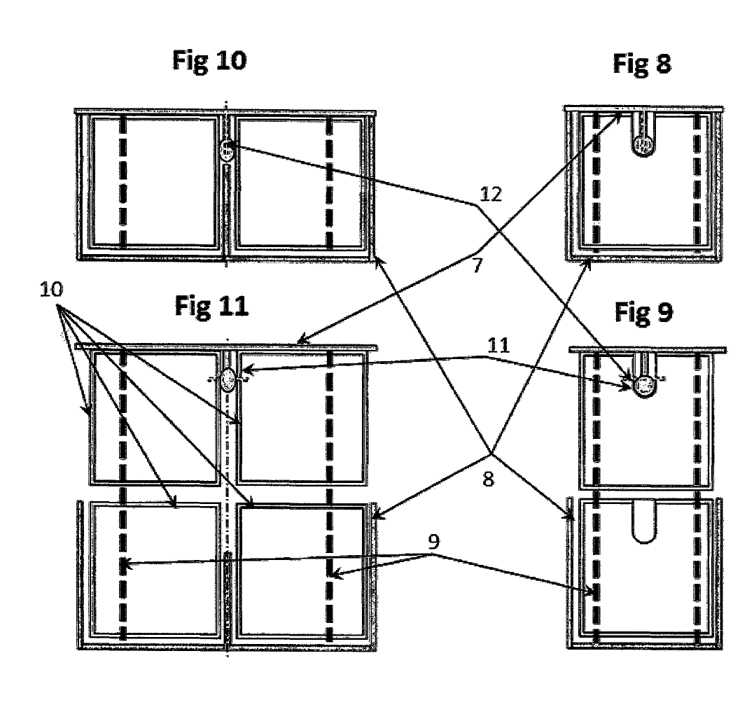

The main elements of the concept are defined as follows:
“Equipped module” (FIG. 2) is intended to mean the assembly of the different parts of the concept (ladders, containers, unit frame). The height (H) is limited to the height of the room, the depth (P) depends upon the use of the module and the length (L) depends upon the volume to be stored and the load permitted by the container.
“Ladder” (FIG. 3, FIG. 6/7 (6)) is intended to mean everything that characterizes the various mechanisms of the vertical uprights ensuring the vertical guidance (rail, roller, rack, or otherwise) of the “platform” (FIG. 7 (2)) provided with latch(es) (FIG. 7 (3)). The various heightwise stopping positions of the “platform” (facing the container to be latched) are ensured by the use of a sensor (inductive or otherwise). Depending upon the weight and volume of the products to be stored by the container, the system can be equipped with one or more ladders. The ladder can be positioned on the movable face (FIGS. 8 to 13) or on the side(s) (FIGS. 5 to 7 and 14 to 20). The ladder slides on runners (FIG. 6/7 (9)), the movement is assisted by a scissor-type mechanism (compass, rack or otherwise) (FIG. 6/7 (5)).
“Container” (FIG. 1/2/4/5 (1)) is intended to mean the storage zones (drawers, shelves, racks, compartments) for storing objects at different levels of the unit. The containers, which must be handled using the “ladder” system, are equipped with an axle(s) allowing for the latching of the latches (FIG. 7 (3), FIG. 9/10/13 (12)). The number and dimensioning of the containers is defined according to the products to be stored. The containers can be independent (moving 1 at a time) or grouped together (several at a time for low heights or loads), in which case the containers are equipped with slides (runners) in order to facilitate access to products stored at each level. Containers that are located within the ergonomic zone can be detached from the system in order to use them as traditional units (with or without runners).
“Platform” (FIG. 6/7 (2)) is intended to mean the movable part moving vertically to which the attachment system, called a “latch” (FIG. 7 (3), FIG. 17 (17), latch, hook, otherwise), of the container is attached. The carriage (platform), moving over the uprights of the ladder, is driven using the toothed belt principle (cable, ball screw or otherwise), and makes it possible to carry the latch(es) (latching mechanism for the containers or otherwise) to the height of the container requested by the user. The latching of the selected container renders it integral to the moving “platform” during all movements according to the arrangement of the user.
“Frame” is intended to mean the external structure of the concept, which makes it possible to connect the ladder(s) to the containers and can support door hinges (that can be motorized), but also facilitates the inclusion of panels (wood, metal, otherwise) in order to ensure the design of the “Equipped module” within the context of the environment thereof.

The schematic diagram (front view FIG. 5 and side view FIG. 6/7) shows (FIG. 5) the ladder (6) and the containers (1) that can be fixed (without use of the system) or movable (using the system) according to the ergonomic level of the user. In the figure (FIG. 6), the containers are stored within the unit, while the ladder (FIG. 7 (6)) is extracted in order to carry the container (5a) to the height required by the user.

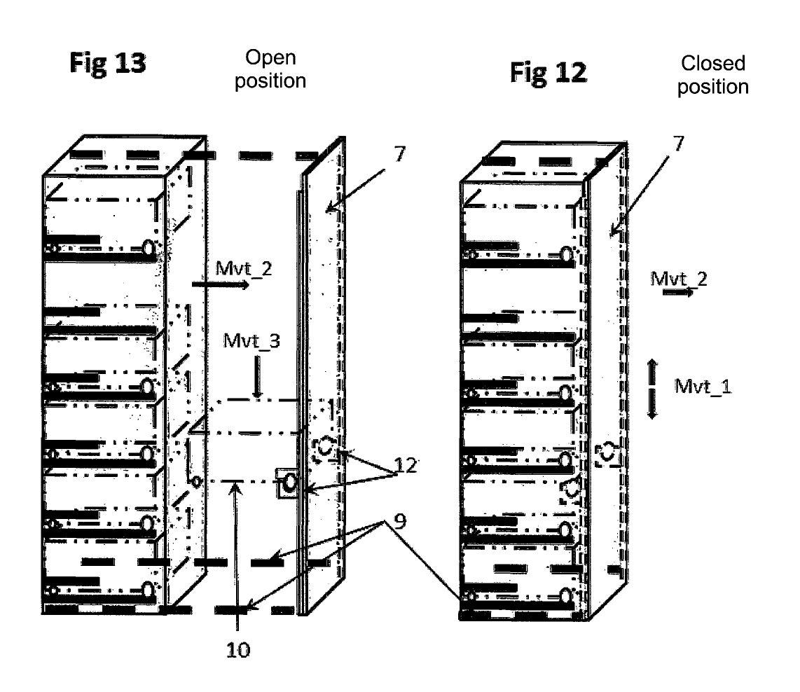

The invention relates to various configurations, in particular as regards the latching principle of the container and the position of the mechanism referred to as a “ladder.” The unit is closed (FIG. 8/10/12/14/16/18) or in the usage position (FIG. 9/11/13/15/17/19). If the “Equipped module” has the “ladder” system attached to the front (FIGS. 8 to 13 (7)), then the vertical movement (11) (belt mechanism, cable, rack, screw-type jack, screwball, or otherwise) is integrated (partially or otherwise) into the container (10). The latching (12) of the container (10) onto the “ladder” (11) is assured by the rotating of hook(s) (12) (the expansion of a mandrel, or otherwise). The runners (9) (telescopic runners with a stroke that is greater than the depth of the unit or otherwise) make it possible to extract (FIG. 9/11/13 Mvt_2) the chosen container of the unit (8) before ensuring the vertical movement (FIG. 12/13 Mvt_1 then Mvt_3) of the chosen container.

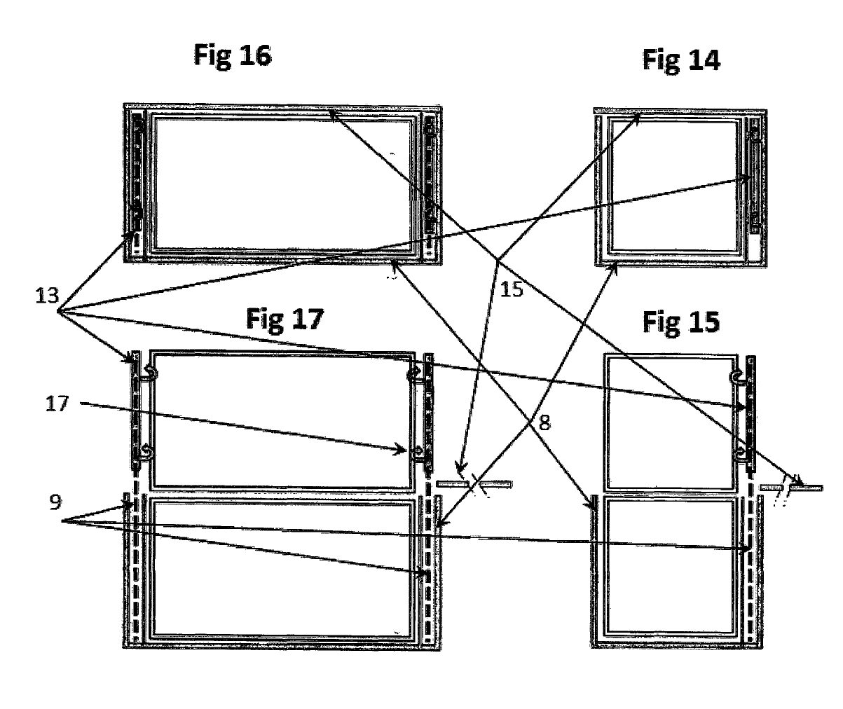

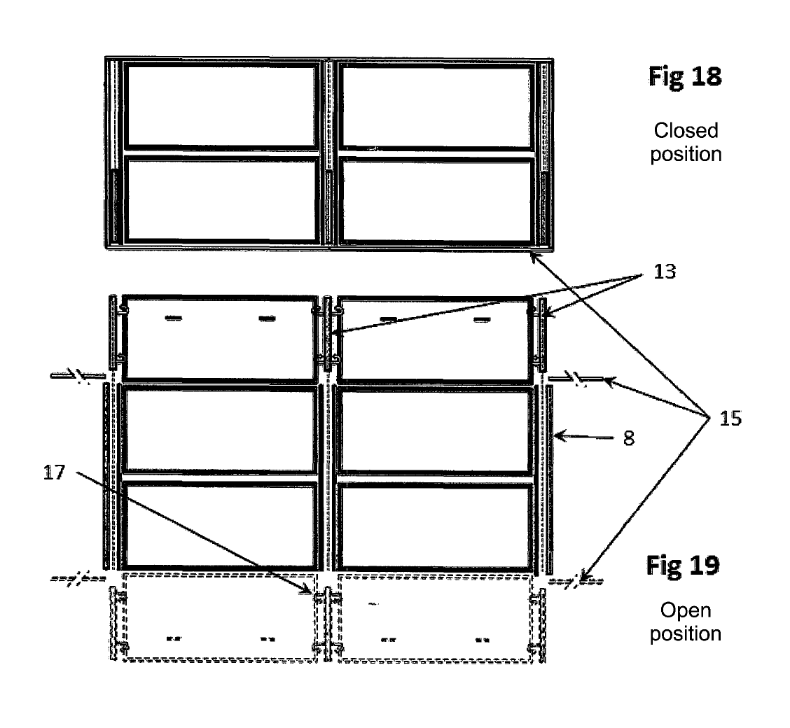

Another configuration (FIGS. 5 to 7 and 14 to 19) has, on the side of the unit (8), a ladder (FIG. 14/15 (13)) or two ladders (FIG. 16-19 (13)) that can translate on runners (9). A door (15) can close the unit, and the opening or closing of the door can be manual or motorized. Depending upon the requirement, a simple version (FIG. 14/15) is suitable for light loads (the container is cantilevered on the ladder), while the double-ladder version (FIG. 16/19) accepts greater lengths (L) or/and loads for the containers. The combination of several “Equipped modules” (FIG. 18/19) increases the storage volume and limits the number of ladders (13).

The different displacements (FIG. 1 Mvt_1 to Mvt_3) can be controlled manually with the entry or extraction movement of the ladder (6), and the rising or lowering of the container is performed by the rotation of a wheel (linked to the pulley and toothed belt) driving the vertical movement of the platform (2) and by remote control by means of a cable (for the latching of the container). These different movements (FIG. 1 Mvt_1 to Mvt_3) can also be motorized and automated (partially or completely) in order to facilitate the use of the concept, especially for people with disabilities. In addition, the automation of the movements makes it possible to define those persons having access to certain containers, according to the code used on the control panel.

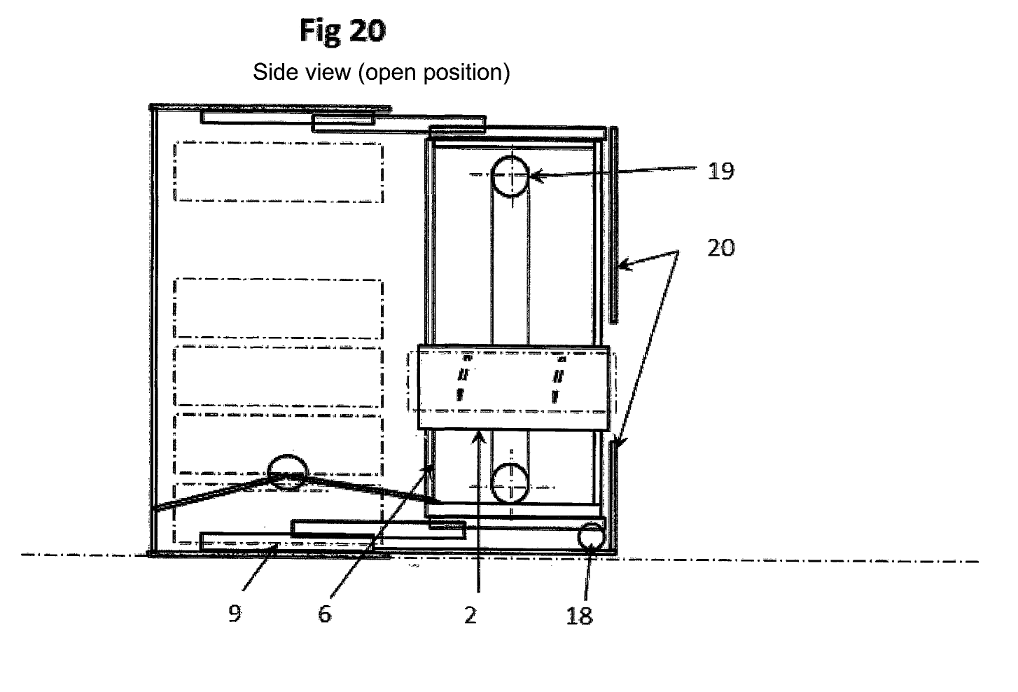

With regard to the safety of the user, several solutions can be combined according to the weight and height of the products stored. In order to prevent the unit from tilting, when the ladder (FIG. 20 (6)) is extracted from the unit, a roller (18) is added beneath the runners (9). In order to avoid the “jamming” of the user beneath the container, the device is equipped with an anti-pinching system and/or a moving parts (ladder (6), platform (2), pulley (19), etc.) force limiter. For very tall installations, fall protection mechanisms (similar to the elevator principle) can be added. The falling object is blocked by the implementation of panels (20) (mesh, net, etc.) that are integral to the ladder (6).

The device according to the invention is particularly intended to increase the storage volume of a zone, to facilitate the grasping of an object (product) stored out of reach without the use of a booster-chair (chair, step ladder, platform, forklift, etc.). The device combines fixed or sliding shelving within the ergonomic zones of the user and movable containers, outside the ergonomic zone, which can be carried to the height of the user by the invention. The application of the invention provides people with disabilities (wheelchair or other physical disability) with additional, accessible storage space without increasing the occupied floor space. The application finds application in private homes (kitchen, dressing room, garage, etc.), but also in a professional context in a business (pharmacy or otherwise in order to optimize the storage zone), in an office (to facilitate access for wheelchair users, repository zones, etc.), in companies (optimizing picking zones without the use of platforms, forklifts, expensive stackers, cranes, etc.). The device can be motorized and automated, and it allows for the authorization of access (or otherwise) to each container to certain users depending upon the rights that are assigned.

1. A device for providing ergonomic access to products the device comprising:
a frame;
supports fixed to the frame;
containers for holding products, each of the containers positioned on the supports, the containers comprising one of movable containers and fixed containers;
a vertical ladder positioned inside the frame;
at least one sliding runner connecting the vertical ladder to the frame;
a platform guided on uprights of the vertical ladder, the platform supporting at least one of the movable containers and adapted to move vertically;
at least one latch mounted to the platform, the at least one latch adapted to engage axles of the movable containers;
mechanism adapted to extract the vertical ladder from the frame, wherein the vertical ladder is adapted to horizontally transfer the one of the movable containers out of the frame and to carry the one of the movable containers to a position required by a user,
wherein the vertical ladder is extractable from the frame in order to allow for vertical displacement of the one of the movable containers and allowing access to a front and side walls of the one of the movable containers when the one of the movable containers is positioned at the position required by the user.

2. The device according to claim 1, wherein the vertical ladder positioned inside the frame comprises a plurality of ladders, each of the plurality of ladders positioned on each side of the containers.

3. The device according to claim 1, wherein the vertical ladder positioned inside the frame does not access the fixed containers.

4. The device according to claim 1, wherein the device further comprises a door mounted to the frame.

5. The device according to claim 1, wherein the device accepts an absence of containers in select zones of the frame.

6. The device according to claim 1, wherein one or more of the movable containers incorporate drawers on runners.

7. The device according to claim 1, wherein movement of the movable containers can be performed manually, in whole or in part.

8. The device according to claim 1, wherein the platform is driven by a motorized belt.

9. The device according to claim 1, wherein the mechanism adapted to extract the vertical ladder comprises a scissor-type mechanism.

10. The device according to claim 1, wherein the user comprises a wheelchair user.
